(19) United States
(12) Patent Application Publication
(10) Pub. No.: US 2015/0006389 A1
(43) Pub. Date: Jan. 1, 2015

(54) Methods and Systems for Managing Payments Between Payor and Payee

(71) Applicant: DATAVI, LLC, Plano, TX (US)

(72) Inventors: David B. Dean, Plano, TX (US); Richard Powell, Plano, TX (US)

(73) Assignee: DATAVI, LLC, Plano, TX (US)

(21) Appl. No.: 14/280,098

(22) Filed: May 16, 2014

Related U.S. Application Data
(60) Provisional application No. 61/840,570, filed on Jun. 28, 2013.

(51) Int. Cl. G06Q 20/10; G06F 19/00; G06Q 20/30

(52) U.S. Cl. CPC G06Q 20/10; G06Q 20/30; G06F 19/328
USPC 705/44

(57) ABSTRACT

A method of managing payments between a payor and a payee includes receiving by the payee a letter and a negotiable instrument made payable to the payee. The letter contains a uniform resource locator (URL) of a web page configured to create an online account responsive to transaction data from the payee. The transaction data includes verification information verifying and associating the payee to the payor and includes the payee's bank account information. The payee can receive the payment via an electronic fund transfer or by depositing the negotiable instrument at a financial institution. A payment system includes a negotiable instrument made payable to the payee and a letter containing a URL of a web page configured to create an online account responsive to verification information verifying and associating the payee to a payor and responsive to the payee's bank account information.

### CROSS-REFERENCE TO RELATED APPLICATION

This application claims the benefit of U.S. Provisional Application Ser. No. 61/840,570 filed by Richard Powell, on Jun. 28, 2013, entitled “System and Method Employing a Hybrid Check,” commonly assigned with this application and incorporated herein by reference.

### TECHNICAL FIELD

This application is directed, in general, to payment processing systems and, more specifically, to methods and systems for managing payments between payors and payees.

### BACKGROUND

When individuals and businesses seek to receive a benefit or a payment conferrable under a contract, for example an insurance contract, payors and payees are often burdened with redundant paperwork such as completing multiple forms and submitting different pieces of information or transaction data. A payor (e.g., an insurance company) may be obligated to make a payment to a payee (e.g., a physician or hospital) that provides medical services to a patient under an insurance contract. The insurance company may also be required to make a payment to a payor (e.g., a patient) as a reimbursement for incurred out of pocket expenses.

The physician may be required to complete multiple forms and provide transaction data in order to receive payment for the services from the insurance company. Similarly, the patient may be required to complete multiple forms and provide transaction data in order to receive reimbursement from the insurance company.

Accordingly, improved methods and systems for managing payments between a payor and a payee are desired. More particularly, methods and systems that manage payments while reducing burdensome and redundant paperwork are desired.

### SUMMARY

According to certain disclosed embodiments, a method of managing payments between a payor and a payee includes receiving by the payee a letter and a negotiable instrument made payable to the payee. The letter contains a uniform resource locator (URL) of a web page configured to create an online account responsive to transaction data from the payee. The transaction data includes verification information verifying and associating the payee to the payor and includes the payee's bank account information. The payee can receive the payment via an electronic fund transfer or by depositing the negotiable instrument at a financial institution.

According to certain disclosed embodiments, the negotiable instrument is a check attached to the letter. The bank account information includes an account number and a routing number. The verification information includes the payee's personal identification information.

According to certain disclosed embodiments, a method of managing payments between a payor and a payee includes providing a letter and a negotiable instrument made payable to the payee. The letter contains a uniform resource locator (URL) of a web page configured to create an online account responsive to transaction data from the payee. The transaction data includes verification information verifying and associating the payee to the payor and includes the payee's bank account information. The payee can receive the payment via an electronic wire transfer or by depositing the negotiable instrument at a financial institution.

According to certain disclosed embodiments, creating the online account includes accessing by the payee the web page. The method includes providing verification information by the payee verifying the payee and associating the payee to the payor. The method includes providing bank account information by the payee to enable the electronic wire transfer. The method includes executing the electronic wire transfer of the payment in response to the creation of the online account.

According to certain disclosed embodiments, a payment system includes a letter and a negotiable instrument made payable to the payee. The letter contains a uniform resource locator (URL) of a web page configured to create an online account responsive to transaction data from the payee. The transaction data includes verification information verifying and associating the payee to the payor and includes the payee's bank account information. The payee can receive a payment by an electronic wire transfer or by depositing the negotiable instrument at a financial institution.

### BRIEF DESCRIPTION

Reference is now made to the following descriptions taken in conjunction with the accompanying drawings, in which:

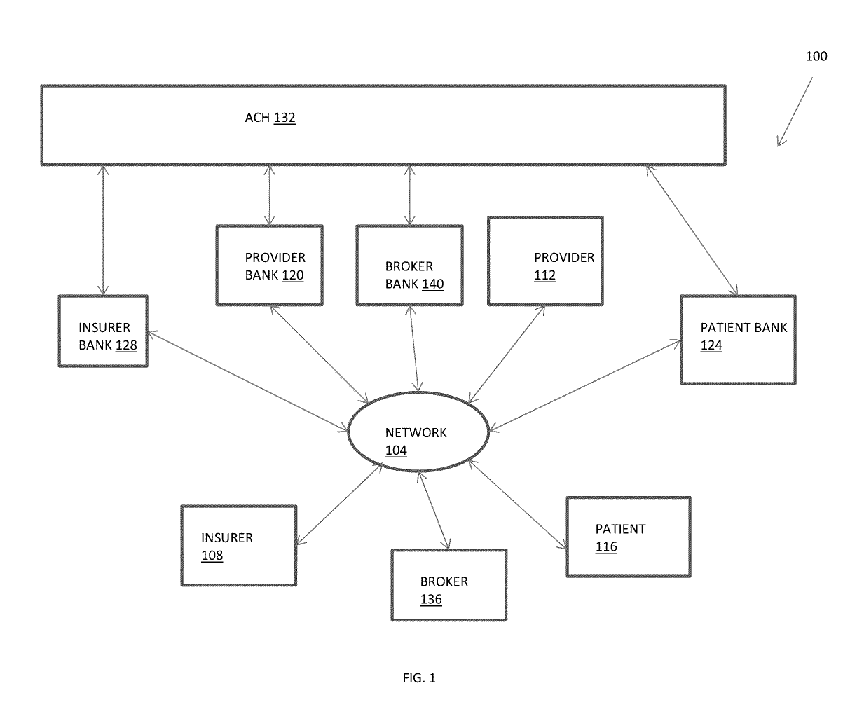

FIG. 1 is a block diagram of one embodiment of a payment system;

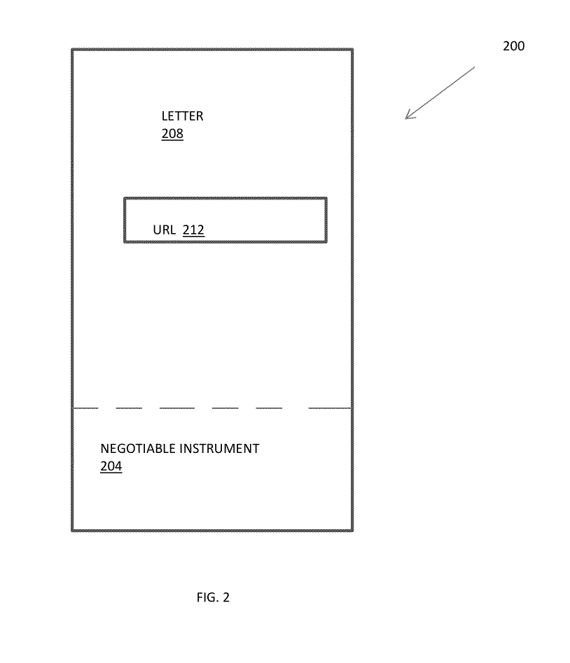

FIG. 2 illustrates a letter and a negotiable instrument according to one embodiment;

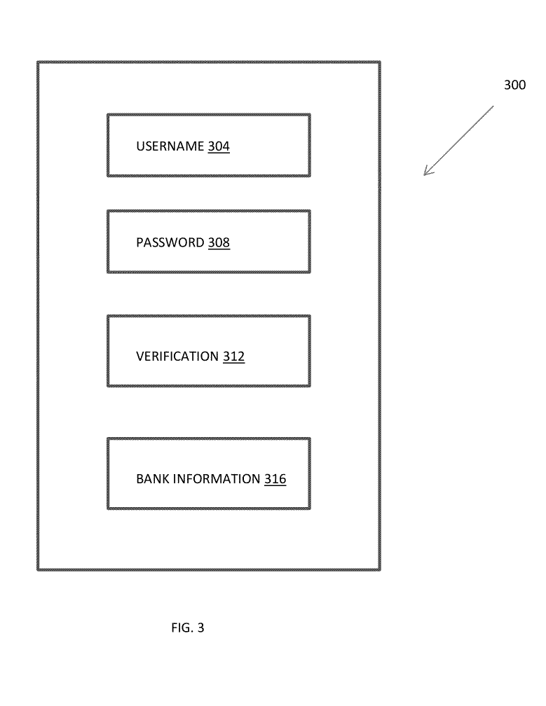

FIG. 3 illustrates a web page according to one embodiment; and

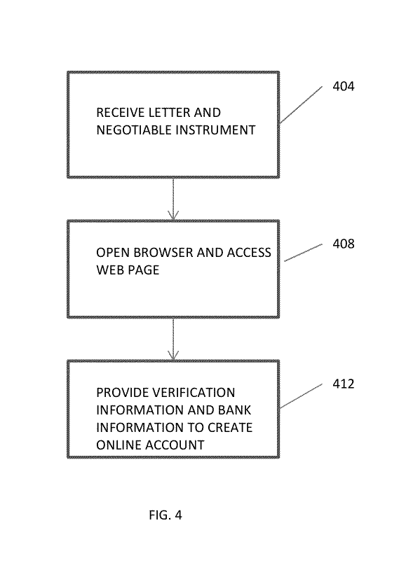

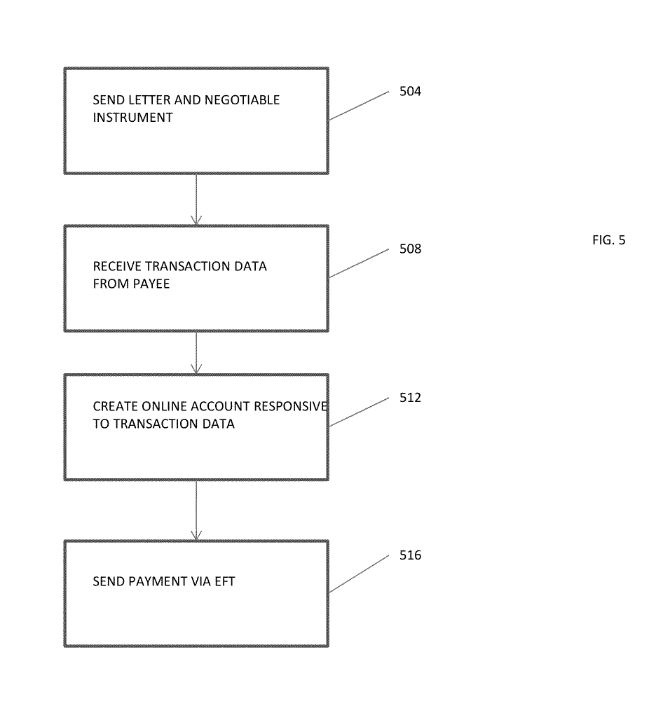

FIGS. 4 and 5 are flow diagrams according to disclosed embodiments.

### DETAILED DESCRIPTION

As discussed before, payors and payees are often burdened with redundant paperwork in order to process or receive a payment. It is realized herein that a network-based system and method for managing payments can reduce redundant paperwork, thus reducing overhead costs to the payors and payees.

It is realized herein that a network-based system and method for managing payments between a payor and a payee can be implemented with a plurality of computers connected to a network such as the Internet. Payors (e.g., insurers) and payees (e.g., providers and patients) can gain access to the network through terminals, which can be either physical terminals or virtual terminals.

FIG. 1 is a block diagram of one embodiment of payment system 100. Payment system 100 includes network 104 communicably coupling insurer terminal 108, provider terminal 112, patient terminal 116, provider bank 120, patient bank 124, broker 136, broker bank 140, and insurer bank 128. Additionally, provider bank 120, patient bank 124, broker bank 140, and insurer bank 128 are communicably coupled by ACH network 132.

ACH network 132 is an electronic network for financial transactions administered by NACHA—The Electronic Payments Association. ACH network 132 is the backbone for the electronic movement of money and data in a safe, secure, and reliable manner. Financial transactions among provider bank 120, patient bank 124, and insurer bank 128 flow through ACH network 132. These financial transactions are direct account-to-account payments. Financial transactions, i.e. flows of money involving credits and debits in various accounts, are initiated with ACH network 132 by an originator through an originating depository financial institution (ODFI) and authorized by a receiver through a receiving depository financial institution (RDFI). Financial transactions between provider bank 120 and insurer bank 128 include payment of claims and, in some circumstances, refund of payment. Financial transactions between provider bank 120 and patient bank 124 include co-pays, deductibles, and payment for services. Payment for services includes circumstances where the payor and patient are the same entity and where the patient is obligated to pay predetermined portion, or “co-insurance,” for the service provided. Financial transactions between patient bank 124 and insurer bank 128 include reimbursements and premiums. ACH network 132 is suitable for a variety of account types common to the financial industry, including checking accounts, debit accounts, credit accounts, general purpose reloadable (GPR) cards, digital wallet, insurer to patient payments (e.g., FSA, HSA) among others.

According to certain disclosed embodiments, broker 136 may be authorized to sell health insurance policies and other financial products offered by insurer 108 to patient 116. Insurer 108 may pay a commission or make other payments to broker 136 for selling health insurance policies and other products. Broker bank 140 may receive payments from insurer bank 128 through ACH 132.

Network 104 is a communication network, such as the world wide web, capable of communicably coupling two or more entities. Network 104 may include, at various access points, wired networks, optical networks, and wireless networks.

FIG. 2 illustrates payment system 200 according to certain disclosed embodiments. Payment system 200 includes negotiable instrument 204 and letter 208. Negotiable instrument 204 is made payable to a payee by a payor. The payor may, for example, be an insurance company, a provider or a patient. The payee may, for example, be a patient, a provider, an insurance company or a broker.

According to disclosed embodiments, the payment represented by the negotiable instrument may, for example, be conferred under an insurance contract. Negotiable instrument 204 may be attached to letter 208 but may easily be detachable, or may otherwise be provided with letter 208. Letter 208 may include an explanation of the payment. Negotiable instrument 204 may be a conventional check which the payee may deposit at a financial institution (e.g., bank) to receive the payment.

According to certain disclosed embodiments, letter 208 includes uniform resource locator (URL) 212 of a web page 300 shown in FIG. 3. By opening a browser on a computer terminal and typing the URL, the payee can access web page 300 which is configured to create an online account of the payee. The online account is created in response to transaction data provided by the payee.

According to certain disclosed embodiments, transaction data may include verification information which verifies and associates the payee to a payor and includes the payee's bank account information. Transaction data may also include insurance information, benefit information, details of the service, details of the payment, a benefit report, such as an FOB, a payment report, such as an RA, and any other data generated during the course of providing the service and arranging for and executing payment.

Bank information is any information used to execute an electronic fund transfer (EFT) to or from a bank account. Bank information includes bank name, bank address, routing number, account number, account type, account holder name, account holder address, and many other pieces of data. Bank information for a single entity should include that which is necessary to execute a financial transaction through the ACH network.

Insurance information is any information related to an insurance policy carried by a beneficiary and provided by an insurer. Insurance information typically includes identifying information such as a policy number, group number, and policy type. Insurance information also includes policy details such as premiums, co-pays, deductibles, co-insurance, policy maximums, out-of-pocket maximums, covered participants, covered providers, covered services, negotiated rates, and many other pieces of information.

Benefit information is information related to a provided benefit. In the healthcare industry, for example, benefit information is health information, which is any information related to a given person's health and healthcare. Health information includes medical history and HIPAA forms. Health information can also include details of the service received, or benefit details. Benefit details are pieces of information relevant to a particular benefit provided. For example, benefit details for a doctor visit can include reasons for the visit, symptoms, doctor notes, prescriptions, test results, and any other information relevant to the visit.

According to certain disclosed embodiments, letter 208 may include a payee participant ID that identifies a payee and a payor participant ID that identifies a payor. The payee may be be required to provide the payee participant ID and the payor participant ID during the verification process.

Web page 300 may be generated by a web server (not shown in FIG. 3) configured to generate a web page. The web server may include program code configured to generate the web page responsive to the transaction data provided by the payee. Web page 300 includes a location labeled Username 304 wherein the payee may type in a chosen user name and a location labeled Password 308 wherein the payee may type in a chosen password. Web page 300 also includes a location labeled Verification Information 312 wherein the payee may type in verification information. Web page 300 also includes a location labeled Bank Information 316 wherein the payee may type in bank information. Responsive to inputs from the payee, web page 300 creates an online account. The payee can access the online account by using his or her username and password.

It will be appreciated that by creating the online account, the payee (e.g., provider or patient) may conveniently receive the payment via an electronic fund transfer without the need to complete burdensome paperwork such as completing multiple forms. Once created, the online account may be used to receive future payments from the payor without redundant paperwork. Similarly, the payor can process and send the payment to the payee electronically without the need to do burdensome paperwork. Also, the payor can use the online account to send future payments to the payee without redundant paperwork. Consequently, embodiments of the invention reduce overhead costs to providers and insurers. Also, patients experience a more streamlined process as redundant paperwork is reduced.

As discussed before, the payee can create the online account by providing transaction data including verification information that may be used to verify the payee. By way of example, verification information may include the payee's name, date of birth, social security number, provider number, Medicare or Medicaid ID, insurer name and insurance ID or any other information that may be used to verify the payee and to associate the payee to the payor. The payee is also required to provide bank information which may include bank account number and routing number to enable the payor, which may, for example, be insurer 108, to electronically transfer funds to the payee's account at provider bank 120 or patient bank 124. The payment may be electronically transferred from insurer bank 128 through ACH 132 to provider bank 112 or patient bank 124. According to certain disclosed embodiments, system 100 may be managed and operated by a third-party service provider. Also, system 100 may be managed and operated by a payor such as an insurance company.

FIG. 4 is a flow diagram of method 400 of managing payments between a payor and a payee according to certain disclosed embodiments. In step 404, the payee receives a letter and a negotiable instrument made payable to the payee. The negotiable instrument may be a check drawn as a payment from the payor conferrable under an insurance contract. The letter contains a URL of a web page configured to create an online account for the payee.

In step 408, the payee opens a browser on a computer terminal and types in the URL to access the web page. In step 412, the payee provides verification information and bank information on the web page to create an online account. The bank information includes the payee's bank account number and a bank routing number. By creating the online account, the payee elects to receive the payment by electronic fund transfer. In step 416, the payee receives the payment electronically.

FIG. 5 is a flow diagram of method 500 of managing payments between a payor and a payee according to other disclosed embodiments. In step 504, a letter and a negotiable instrument is sent to the payee. The negotiable instrument may be a check drawn as a payment conferrable under an insurance contract. The letter includes a URL of a web page configured to create an online account.

In step 508, transaction data including verification information and bank information from the payee is received through the web page.

In step 512, responsive to the transaction data from the payee, an online account is created for the payee. By creating the online account, the payee elects to receive the payment by an electronic fund transfer. In step 516, the payment amount is electronically transferred to the payee's bank account.

Those skilled in the art to which this application relates will appreciate that other and further additions, deletions, substitutions and modifications may be made to the described embodiments.

What is claimed is:

1. A method of managing payments between a payor and a payee, comprising:
receiving by the payee a negotiable instrument made payable to the payee; and
receiving by the payee a letter containing a uniform resource locator (URL) of a web page configured to create an online account responsive to verification information verifying and associating the payee to the payor and responsive to the payee's bank account information, wherein the payee can receive the payment via an electronic fund transfer or by depositing the negotiable instrument at a financial institution.

2. The method of claim 1, wherein the negotiable instrument is a check attached to the letter.

3. The method of claim 2, wherein the negotiable instrument and said letter are printed on a single page.

4. The method of claim 1, wherein the payment is a benefit conferrable under an insurance contract.

5. The method of claim 1, wherein the bank account information includes an account number and a routing number.

6. The method of claim 1, wherein the verification information includes the payee's personal identification information.

7. The method of claim 1, wherein the letter provides information relating to the payment.

8. The method of claim 1, wherein the web page provides information relating to the payment.

9. A method of managing payments between a payor and a payee, comprising:
providing a negotiable instrument made payable to the payee; and
providing a letter containing a uniform resource locator (URL) of a web page configured to create an online account responsive to verification information verifying and associating the payee to the payor and responsive to the payee's bank account information, wherein the payee can receive the payment via an electronic wire transfer or by depositing the negotiable instrument at a financial institution.

10. The method of claim 9, wherein the negotiable instrument is a check attached to the letter.

11. The method of claim 10, wherein the negotiable instrument and said letter are printed on a single page.

12. The method of claim 9, wherein creating the online account comprises:
accessing by the payee the web page;
providing verification information by the payee verifying the payee and associating the payee to the payor;
providing bank account information by the payee to enable the electronic wire transfer.

13. The method of claim 9, wherein the bank account information includes an account number and a routing number.

14. The method of claim 9, wherein the verification information includes the payee's personal identification information.

15. The method of claim 9, further comprising initiating the electronic wire transfer of the payment in response to the creation of the online account.

16. The method of claim 9, wherein the payment is a benefit conferrable under an insurance contract.

17. The method of claim 9, wherein the letter provides information relating to the payment.

18. The method of claim 9, wherein the web page provides information relating to the payment.

19. A payment system, comprising:
a negotiable instrument made payable to the payee; and
a letter containing a uniform resource locator (URL) of a web page configured to create an online account responsive to verification information verifying and associating the payee to a payor and responsive to the payee's bank account information, wherein the payee can receive a payment by an electronic wire transfer or by depositing the negotiable instrument at a financial institution.

20. The payment system of claim 19, wherein the negotiable instrument is a portion of a page on which said letter is printed the letter.

21. The payment system of claim 19, wherein the bank account information includes an account number and a routing number.

22. The payment system of claim 19, wherein the payment is a benefit conferrable under an insurance contract.
